(19) United States
(12) Patent Application Publication
(10) Pub. No.: US 2011/0189328 A1
(43) Pub. Date: Aug. 4, 2011

(54) PRINTING MOLD FOR NANOIMPRINT LITHOGRAPHY DEVICE

(75) Inventor: Hsi-Chang WU, Tu-Cheng (TW)

(73) Assignee: HON HAI PRECISION INDUSTRY CO., LTD., Tu-Cheng (TW)

(21) Appl. No.: 12/766,919

(22) Filed: Apr. 25, 2010

(30) Foreign Application Priority Data
Jan. 29, 2010 (TW) 99102546

(51) Int. Cl. B28B 11/08

(52) U.S. Cl. 425/385

(57) ABSTRACT

A nanoimprint lithography device includes a base, a pair of opposite rotator formed on the base, and a printing mold connected to the rotators. The printing mold includes a cylindrical main body having a nanometer-scale pattern formed thereon and a pair of connecting piece detachably connected to the main body. The printing mold is connected to the rotators via the connecting pieces and is configured to be driven by the rotators to print the nanometer-scale pattern on a substrate.

### BACKGROUND

1. Technical Field

The present disclosure relates to nanoimprint lithography technologies and, particularly, to a printing mold for nanoimprint lithography device. The printing mold can engage with engraving machines through different methods.

2. Description of Related Art

A nanoimprint lithography device typically includes a printing mold for printing a nanometer-scale pattern on a substrate. The printing mold needs to engage with an engraving machine to form the nanometer-scale pattern on the printing mold before the printing mold is engaged with the nanoimprint lithography device to work.

Generally, the printing mold typically includes a cylindrical main body having the nanometer-scale pattern formed thereon, and a pair of elongated connecting rods correspondingly extending from two opposite ends of the main body. However, a special kind of engraving machine that engages with the printing mold through a vacuum sucker has difficulty sucking the connecting rods because the cross-sections of the connecting rods are too small.

Therefore, it is desirable to provide a printing mold which can overcome the above-mentioned shortcoming.

### BRIEF DESCRIPTION OF THE FIGURE

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a nanoimprint lithography device according to one embodiment.

FIG. 2 is an exploded, schematic view of a printing mold of the nanoimprint lithography device of FIG. 1.

FIG. 3 is an assembled, schematic view of the printing mold of FIG. 2.

FIG. 4 is a schematic view of the printing mold and an engraving machine, when the printing mold engages with the engraving machine.

### DETAILED DESCRIPTION

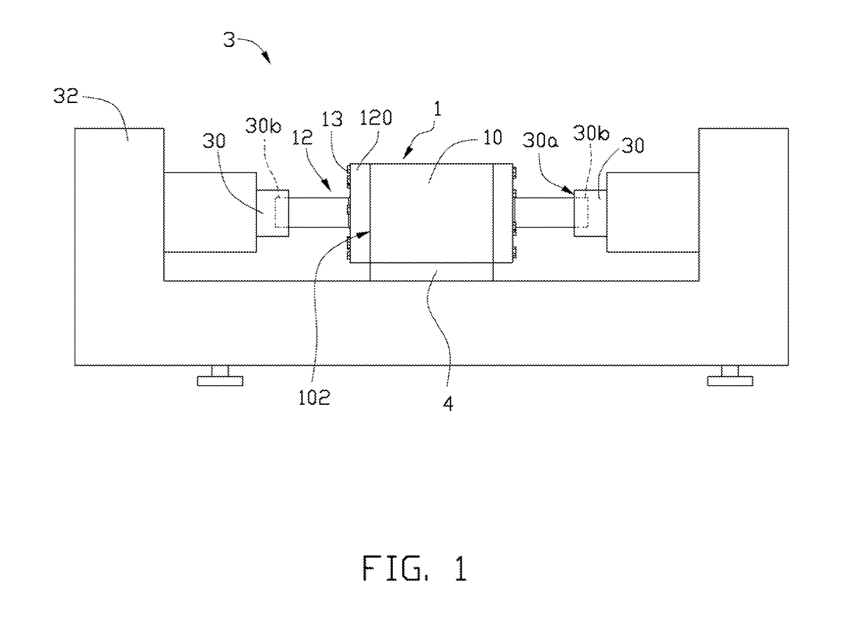

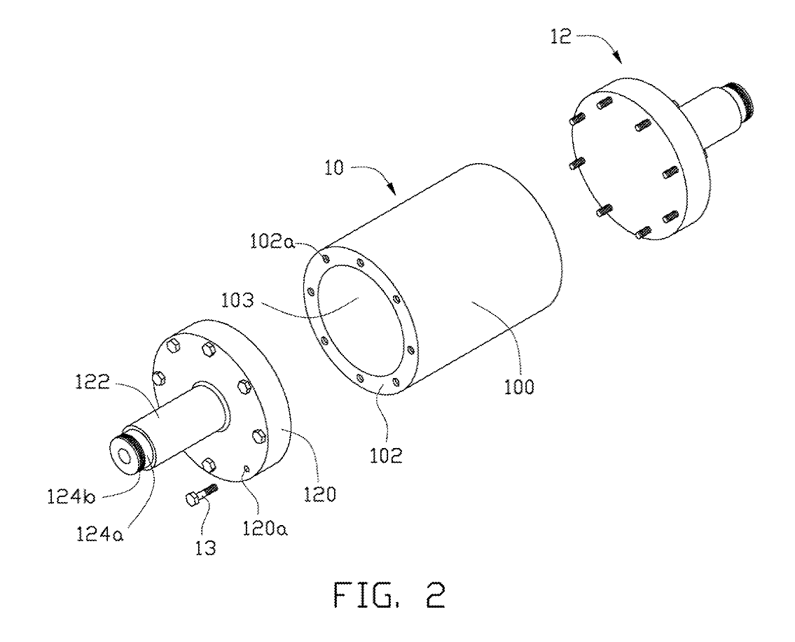

Referring to FIGS. 1 and 2, a nanoimprint lithography device 3 in accordance with one embodiment of present disclosure is shown. The nanoimprint lithography includes a base 32, a pair of opposite rotators 30 formed on the base 32 and a printing mold 1 held by the rotators 30.

Each rotator 30 is cylindrical shaped and includes a circular connecting end surface 30a. Each rotator 30 defines a first threaded hole 30b in a center of the connecting end surface 30a.

The printing mold 1 includes a main body 10, a pair of connecting pieces 12, and a number of bolts 13. The main body 10 is substantially a hollow cylindrical column and includes a cylindrical outer surface 100 and a pair of annular side surfaces 102. The side surfaces 102 are correspondingly connected to two opposite sides of the outer surface 100. The main body 10 defines a receiving space 103 as a cylindrical internal surface of the main body 10. A nanometer-scale pattern is formed on the outer surface 100. The printing mold 1 defines a number of second threaded holes 102a in each of the side surfaces 102 at predetermined intervals. The receiving space 103 is configured for accommodating a cooling water pipe (not shown) to reduce the temperature of the printing mold 1.

Each connecting piece 12 includes a straight connecting rod 122 and a flange 120. The flange 120 is a substantially circular plate. Each connecting piece 12 defines a number of through holes 120a at a peripheral portion of the flange 120 spatially corresponding to the second threaded holes 102a. The connecting rod 122 perpendicularly extends from a center of one side of the flange 120. Each connecting piece 12 defines a screw thread 124b on a distal end 124a of the connecting rod 122 far from the flange 120.

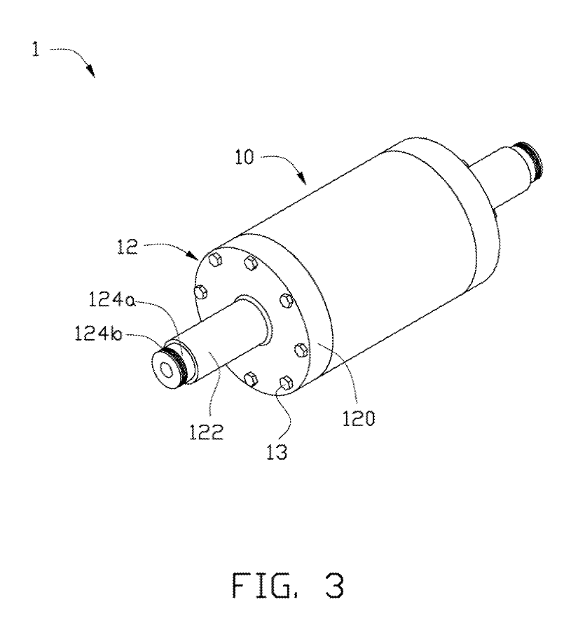

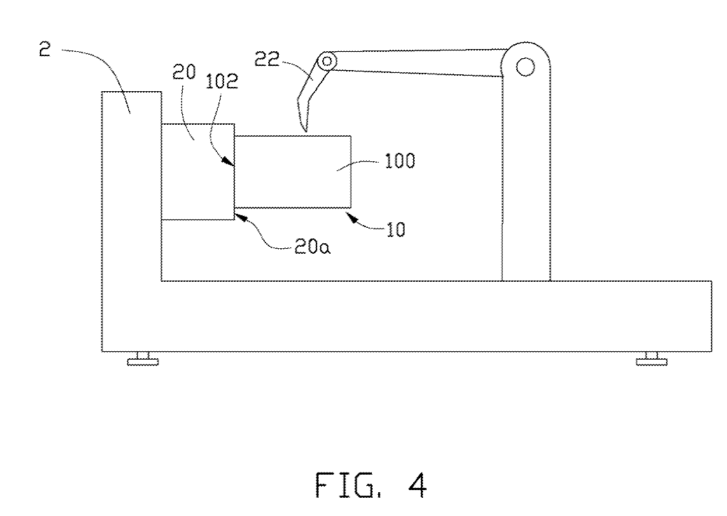

Also referring to FIGS. 3 and 4, an engraving machine 2 is provided to form the nanometer-scale pattern on the outer surface 100 of the main body 10 before the printing mold 1 is engaged with the nanoimprint lithography device 3. The engraving machine 2 includes a vacuum sucker 20 and an engraver 22. The main body 10 is fastened to the engraving machine 2, when the vacuum sucker 20 sucks one of the side surfaces 102. The engraver 22 engraves the nanometer-scale pattern on the outer surface 100 of the main body 10.

The printing mold 1 is engaged with the nanoimprint lithography device 3 through the connecting pieces 12 after the nanometer-scale pattern is formed on the outer surface 100 of the main body 10. The flanges 120 are correspondingly aligned to the side surfaces 102 and are fixed by screwing the bolts 103 into the second threaded holes 102a via the through holes 120a. Therefore, the connecting pieces 12 are correspondingly fastened to the main body 10. The distal end 124a of each connecting rod 122 correspondingly screws into the first threaded holes 30b to fix the printing mold 1 with the rotators 30. A substrate 4 is placed under the main body 10. The printing mold 1 is rotated by the rotator 30 to press and print the nanometer-scale pattern on the substrate 4.

While various embodiments have been described, it is to be understood that the invention is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A printing mold comprising:
a main body comprising an outer surface and a pair of side surfaces perpendicularly connecting two opposite sides of the outer surface;
a pair of connecting pieces, each connecting piece comprising a flange and a connecting rod perpendicularly extending from a center of one side of the flange; and
a plurality of bolts;
wherein the main body defines a plurality of threaded holes in the side surfaces, the connecting piece defines a plurality of through holes in the flanges corresponding to the threaded holes, the connecting pieces are correspondingly fastened to the main body by correspondingly screwing the bolts into the threaded holes via the through holes.

2. The printing mold as claimed in claim 1, wherein the main body is substantially a hollow cylindrical column defining a receiving space, each side surface is annular, and the main body further defines the threaded holes in the side surfaces at predetermined intervals.

3. The printing mold as claimed in claim 1, wherein the flange is a substantially circular plate, and each connecting piece defines a screw thread on a distal end of the connecting rod far from the flange.

4. The printing mold as claimed in claim 1, wherein a nanometer-scale pattern is graved on the outer surface of the main body by an engraving machine.

5. The printing mold as claimed in claim 4, wherein the printing mold is configured to be rotated to press and print the nanometer-scale pattern on a substrate.

6. A nanoimprint lithography device, comprising:
a base;
a pair of opposite rotators formed on the base; and
a printing mold connected to the rotators, the printing mold comprising:
a main body comprising an outer surface and a pair of side surfaces perpendicularly connecting two opposite sides of the outer surface;
a pair of connecting pieces, each connecting piece comprising a flange and a connecting rod perpendicularly extending from a center of one side of the flange, and the connecting rod having a distal end far from the flange; and
a plurality of bolts fastening the connecting pieces to the main body;
wherein each connecting piece correspondingly engages with a respective one of the rotators via the distal end of the connecting rod.

7. The nanoimprint lithography device as claimed in claim 6, wherein each rotator is cylindrical shaped and comprises a circular connecting end surface.

8. The nanoimprint lithography device as claimed in claim 7, wherein each rotator defines a first threaded hole in a center of the connecting end surface; each connecting rod defines a screw thread on the distal end, and each connecting piece correspondingly engages with the rotator by screwing the distal end into the first threaded hole.

9. The nanoimprint lithography device as claimed in claim 6, wherein the main body is substantially a hollow cylindrical column defining a receiving space, and the side surface is annular.

10. The nanoimprint lithography device as claimed in claim 9, wherein the main body further defines a plurality of second threaded holes in the side surface at predetermined intervals; the flange is a substantially circular plate, the connecting piece defines a plurality of through holes in the flanges spatially corresponding to the second threaded holes, and the connecting pieces are correspondingly fastened to the main body by screwing the bolts into the second threaded holes via the through holes.

11. The nanoimprint lithography device as claimed in claim 6, wherein a nanometer-scale pattern is graved on the outer surface of the main body by an engraving machine.

12. The nanoimprint lithography device as claimed in claim 11, wherein the printing mold is configured to be rotated by the rotator to press and print the nanometer-scale pattern on a substrate.
